(19) United States
(12) Patent Application Publication
(10) Pub. No.: US 2021/0201721 A1
(43) Pub. Date: Jul. 1, 2021

(54) FOLDABLE DISPLAY PANEL AND FOLDABLE DISPLAY DEVICE

(71) Applicant: Wuhan China Star Optoelectronics Semiconductor Display Technology Co.,Ltd, Wuhan, Hubie (CN)

(72) Inventors: Jihui LI, Wuhan, Hubei (CN); Fuchih CHANG, Wuhan, Hubei (CN)

(21) Appl. No.: 16/957,761

(22) PCT Filed: Apr. 7, 2020
(86) PCT No.: PCT/CN2020/083439

§ 371 Date: Jun. 25, 2020

(30) Foreign Application Priority Data
Dec. 31, 2019 (CN) 20191142530.8

(51) Int. Cl. G09G 3/00

(52) U.S. Cl. CPC G09G 3/035; G09G 2300/0408; G09G 2380/02; G09G 2300/08; G09G 2310/0275; G09G 2330/023; G09G 2310/0267

(57) ABSTRACT

A foldable display panel, by disposing driving integrated circuits at different folding areas and electrically connecting pixel driving circuit units located in corresponding display areas through corresponding data lines to provide corresponding data signals to the display areas, the display areas controlled one-to-one for display are realized, and when at least one of the display areas of the foldable display panel is not required to emit light for display, a driving integrated circuit corresponding to the display area may stop driving to reduce power consumption waste.

### TECHNICAL FIELD

The present invention relates to a field of display technology, and in particular to a foldable display panel and a foldable display device capable of reducing power consumption of driving integrated circuits.

### BACKGROUND

With development of large-sized and medium-sized foldable display panels, there is a growing demand for a resolution that driving integrated circuits (DICs) support, and corresponding needs can no longer be satisfied by one DIC. Therefore, DICs with a cascaded scheme have gradually become a mainstream, wherein two or more DICs are simultaneously used to drive the foldable display panels in a manner of the cascaded approach. However, power consumption of the driving integrated circuits has become a problem that must be solved.

Referring to FIG. 1, which is a schematic diagram showing a foldable display panel 10 in the prior art, the foldable display panel 10 includes a thin film transistor array substrate 11. The thin film transistor array substrate 11 has a first display area 112, a second display area 114, and a first driving integrated circuit 122 and a second driving integrated circuit 124 which are disposed at a non-display area 116, wherein the first display area 112 and the non-display area 116 belong to a first folding area (not marked), the second display area 114 belongs to a second folding area (not marked), and the first folding area and the second folding area are configured to be folded along a folding axis 12. When the first folding area and the second folding area are expanded with respect to the folding axis 12, the first display area 112 and the second display area 114 will emit light for display, and the first driving integrated circuit 122 and the second driving integrated circuit 124 will provide scan signals and data signals, so that pixel driving circuit units (not shown) located in the first display area 112 and the second display area (that is, a display area) can be driven to emit light for display. In addition, when the first folding area and the second folding area are folded with respect to the folding axis 12, one of the first display area 112 or the second display area 114 will emit light for display, the other area will be in a dark-screen state, and both the first driving integrated circuit 122 and the second driving integrated circuit 124 continue to provide scan signals and data signals to the display area. Compared with an expanded state, power consumption of the first driving integrated circuit 122 and the second driving integrated circuit 124 is not relatively reduced, thus causing a waste of power consumption.

Therefore, in order to effectively solve a problem of power consumption waste of the driving integrated circuits, it is necessary to provide a foldable display panel and a foldable display device to solve the problems in the prior art.

### Technical Problem

An objective of the present invention is to provide a foldable display panel and a foldable display device to solve a problem of power consumption waste of driving integrated circuits (DICs).

### Technical Solution

To achieve the above objective, a first aspect of the present invention provides a foldable display panel, comprising:

a substrate, at least comprising a first folding area and a second folding area, the first folding area comprising a first display area and a first non-display area, the second folding area comprising a second display area and a second non-display area, the first display area and the second display area configured to be folded along a first folding axis, and the first non-display area and the second non-display area configured to be folded along the first folding axis;

a thin film transistor layer, disposed on the substrate and comprising a plurality of pixel driving circuit units;

a first driving integrated circuit, disposed at the first non-display area of the substrate and electrically connected to the plurality of pixel driving circuit units located in the first display area through corresponding data lines to provide corresponding data signals to the first display area; and

a second driving integrated circuit, disposed at the second non-display area of the substrate and electrically connected to the plurality of pixel driving circuit units located in the second display area through corresponding data lines to provide corresponding data signals to the second display area.

Further, the foldable display panel further comprises:

at least one gate-on-array (GOA) drive circuit, disposed on the substrate and located at at least one side of the first folding axis, and electrically connected to the plurality of pixel driving circuit units,

wherein the at least one GOA drive circuit is electrically connected to a driving integrated circuit disposed at a same side as the at least one GOA drive circuit with respect to the first folding axis to provide corresponding scan signals.

Further, the at least one GOA drive circuit is electrically connected to the plurality of pixel driving circuit units through corresponding scan lines, and the corresponding scan lines are arranged in a direction running through the first display area and the second display area.

Further, the corresponding data lines located in the first display area and the corresponding data lines located in the second display area are arranged so as not to intersect with the first folding axis.

Further, the first data driving integrated circuit and the second data driving integrated circuit are located at a same end of the data lines.

Further, the first driving integrated circuit and the second driving integrated circuit are electrically connected to each other, a first synchronization signal is transmitted between the first driving integrated circuit and the second driving integrated circuit, and the first synchronization signal is configured to control the first driving integrated circuit and the second driving integrated circuit to synchronously control driving of the plurality of pixel driving circuit units.

Further, when the foldable display panel is in a folded state, one of the first driving integrated circuit or the second driving integrated circuit stops driving, and a display area corresponding to the driving integrated circuit that stops driving is in a standby state.

Further, when the driving integrated circuit that stops driving receives a wake-up signal pulse, the corresponding display area changes from the standby state to a normal working mode with light emission for display.

Further, the substrate further comprises a third folding area comprising a third display area and a third non-display area, the third display area and the second display area are configured to be folded along a second folding axis, and the third non-display area and the second non-display area are configured to be folded along the second folding axis, and the foldable display panel further comprises:

a third driving integrated circuit, disposed at the third non-display area of the substrate and electrically connected to pixel driving circuit units located in the third display area through corresponding data lines to provide third corresponding data signals to the third display area.

Further, the foldable display panel further comprises:

at least one gate-on-array (GOA) drive circuit, disposed on the substrate and located at at least one side of any one of the first folding axis or the second folding axis, and electrically connected to the plurality of pixel driving circuit units,

wherein the at least one GOA drive circuit is electrically connected to a driving integrated circuit disposed at a same side as the at least one GOA drive circuit with respect to any one of the first folding axis or the second folding axis to provide corresponding scan signals.

Further, the at least one GOA drive circuit is electrically connected to the plurality of pixel driving circuit units through corresponding scan lines, and the corresponding scan lines are arranged in a direction running through the third display area.

Further, the corresponding data lines located in the second display area and the corresponding data lines located in the third display area are arranged so as to not intersect with the second folding axis.

Further, the first data driving integrated circuit, the second data driving integrated circuit, and the third data driving integrated circuit are located at a same end of the data lines.

Further, the first driving integrated circuit, the second driving integrated circuit, and the third driving integrated circuit are electrically connected to each other, a second synchronization signal is transmitted among the first driving integrated circuit, the second driving integrated circuit, and the third driving integrated circuit, and the second synchronization signal is configured to control the first driving integrated circuit, the second driving integrated circuit, and the third driving integrated circuit to synchronously control driving of the plurality of pixel driving circuit units.

Further, when the first folding area and the second folding area are in a folded state, one of the first driving integrated circuit or the second driving integrated circuit stops driving, and a display area corresponding to the driving integrated circuit that stops driving is in a standby state.

Further, when the second folding area and the third folding area are in a folded state, one of the second driving integrated circuit or the third driving integrated circuit stops driving, and a display area corresponding to the driving integrated circuit that stops driving is in a standby state.

Further, when the first folding area, the second folding area, and the third folding area are all in a folded state, at least one of the first driving integrated circuit, the second driving integrated circuit, or the third driving the integrated circuit stops driving, and a display area corresponding to the at least one driving integrated circuit that stops driving is in a standby state.

Further, when the at least one driving integrated circuit that stops driving receives a wake-up signal pulse, the corresponding display areas changes from the standby state to a normal working mode with light emission for display.

A second aspect of the present invention provides a foldable display device comprising the foldable display panel described above.

### Beneficial Effect

Based on the above description, according to the present invention, by disposing driving integrated circuits at different folding areas and electrically connecting pixel driving circuit units located in corresponding display areas through corresponding data lines to provide corresponding data signals to the display areas, the display area controlled one-to-one for display is realized, and when at least one of the display areas of the foldable display panel is not required to emit light for display, the driving integrated circuit corresponding to the display area may stop driving to reduce power consumption waste. Further, the present invention can be applied to display panels with three or more display areas. It can be seen that the invention is unobvious and has obvious advantages.

### DESCRIPTION OF DRAWINGS

FIG. 1 is a schematic diagram showing a foldable display panel in the prior art.

FIG. 2 is a schematic diagram showing a foldable display panel according to a first embodiment of the present invention.

FIG. 3 presents a schematic diagram showing a foldable display panel according to a second embodiment of the present invention.

### DETAILED DESCRIPTION OF PREFERRED EMBODIMENTS

To make objectives, technical schemes, and effects of the present invention clearer and more specific, the present invention is described in further detail below with reference to appending drawings. It should be understood that specific embodiments described herein are merely for explaining the present invention, terms “embodiment” and “exemplary” used in the specification means an example, instance, or illustration, and are not intended to limit the present invention.

In the description of the present invention, it should be understood that directional terms or spatially relative terms such as “upper”, “lower”, “row”, “column”, are orientations or directions with reference to the appending drawings, and are merely for describing the present invention and illustrating briefly, which does not indicate or imply that referred equipment or devices must have a specific orientation to construct and operate with a specific orientation. Therefore, it cannot be understood as a limitation to the present invention. Moreover, terms such as “first”, “second”, and “third” are only used for distinguishing exemplary descriptions, and cannot be understood as a limitation to the present invention.

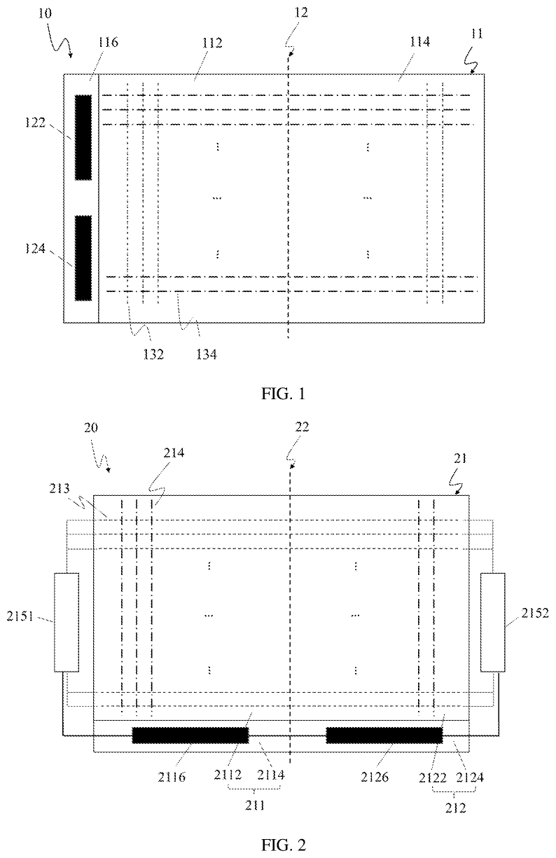

Referring to FIG. 2, which is a schematic diagram showing a foldable display panel according to a first embodiment of the present invention. The first embodiment of the present invention provides a foldable display panel 20 which includes a substrate 21, a thin film transistor layer (not shown), a first driving integrated circuit 2116, and a second driving integrated circuit 2126. The substrate 21 has a first folding area 211 and a second folding area 212, the first folding area 211 has a first display area 2112 and a first non-display area 2114, and the second folding area 212 has a second display area 2122 and a second non-display area 2124. The first folding area 211 and the second folding area 212 are configured to be folded along a first folding axis 22. That is, the first display area 2112 and the second display area 2122 are configured to be folded along the first folding axis 22, and the first non-display area 2114 and the second non-display area 2124 are configured to be folded along the first folding axis 22. Also, the substrate 21 is divided into one side of the first folding area 211 having the first display area 2112 and the first non-display area 2114 and one side of the second folding area 212 having the second display area 2122 and the second non-display area 2124 by the first folding axis 22. In addition, the thin film transistor layer is correspondingly disposed on the substrate 21, and includes a plurality of pixel driving circuit units (not shown) for driving light-emitting pixels. The first driving integrated circuit 2116 is disposed at the first non-display area 2114 of the substrate 21, and the second driving integrated circuit 2126 is disposed at the second non-display area 2124 of the substrate 21. That is, the first driving integrated circuit 2116 and the second driving integrated circuit 2126 are disposed at different folding areas.

In the present embodiment, a plurality of scan lines 213 and a plurality of data lines 214 are disposed in a display area (that is, the first display area 2112 and the second display area 2122), wherein the plurality of scan lines 213 are arranged in a first direction running through the first display area 2112 and the second display area 2122. The plurality of data lines 214 are arranged in a second direction intersecting with the first direction and are arranged as parallel to or so as not intersecting with the first folding axis 22. In an embodiment, the first direction and the second direction are perpendicular to each other, for example, the first direction is a row direction, and the second direction is a column direction, that is, the plurality of scan lines 213 are arranged in the row direction, and the plurality of data lines 214 are arranged in the column direction.

In the present embodiment, the first driving integrated circuit 2116 and the second driving integrated circuit 2126 may be located at the non-display areas located at a same end of different folding areas in the column direction. Specifically, the first driving integrated circuit 2116 and the second driving integrated circuit 2126 may be located at a lower side of the first display area 2112 and a lower side of the second display area 2122, respectively; or, the first driving integrated circuit 2116 and the second driving integrated circuit 2126 may be located at an upper side of the first display area 2112 and an upper side of the second display area 2122, respectively. In another embodiment, the first driving integrated circuit 2116 and the second driving integrated circuit 2126 may be located at different ends of different folding areas in the column direction. Specifically, the first driving integrated circuit 2116 is located at the lower side of the first display area 2112, and the second driving integrated circuit 2126 is located at the upper side of the second display area 2122; or, the first driving integrated circuit 2116 is located at the upper side of the first display area 2112, and the second driving integrated circuit 2126 is located at the lower side of the second display area 2122.

In the present embodiment, the first driving integrated circuit 2116 may be electrically connected to the pixel driving circuit units located in the first display area 2112 through corresponding data lines (not marked) located in the first display area 2112 to provide corresponding data signals to the first display area 2112. The second driving integrated circuit 2126 may be electrically connected to the pixel driving circuit units located in the second display area 2122 through corresponding data lines (not marked) located in the second display area 2122 to provide corresponding data signals the second display area 2122.

In the present embodiment, the foldable display panel 20 further includes at least one gate-on-array (GOA) drive circuit, which is disposed on the substrate 21 and located at at least one side of the first folding axis 22. That is, the GOA drive circuit may include one GOA circuit, or may include two GOA circuits. When there is one GOA circuit, it may exemplarily be located at a non-display area located at a left side of the first display area 2112, or located at a non-display area located at a right side of the second display area 2122. When there are two GOA circuits, they may exemplarily be located at the non-display area located at the left side of the first display area 2112 and the non-display area located at the right side of the second display area 2122, respectively, wherein the non-display areas are areas other than the first non-display area 2114 and the second non-display area 2124. In order to explain the present invention, two GOA circuits are used as a preferred embodiment to illustrate the present invention, and the two GOA circuits are a first GOA circuit 2151 and a second GOA circuit 2152, respectively. The first GOA circuit 2151 is electrically connected to the first driving integrated circuit 2116 disposed at a same side as the first display area 2112 with respect to the first folding axis 22. The second GOA circuit 2152 is electrically connected to the second driving integrated circuit 2126 disposed at a same side as the second GOA circuit 2151 with respect to the first folding axis 22, as shown in FIG. 2. Furthermore, the first GOA circuit 2151 and the second GOA circuit 2152 are electrically connected to the pixel driving circuit units located in the display area through corresponding scan lines located in the display area, respectively, and corresponding scan signals required for light emission for display may be provided by at least one of the first driving integrated circuit 2116 or the second driving integrated circuit 2126. That is, if driving capability of the driving integrated circuits are strong enough, only one driving integrated circuit may be used to transmit the corresponding scan signals to the display area.

In the present embodiment, in order to achieve a higher resolution, the first driving integrated circuit 2116 and the second driving integrated circuit 2126 are connected in a manner of a cascade scheme, so that two driving integrated circuits can be simultaneously used to drive the foldable display panel 20. Specifically, the first driving integrated circuit 2116 and the second driving integrated circuit 2126 are electrically connected to each other, a first synchronization signal is transmitted between the first driving integrated circuit 2116 and the second driving integrated circuit 2126, and the first synchronization signal is configured to control the first driving integrated circuit 2116 and the second driving integrated circuit 2126 to synchronously control driving of the plurality of pixel driving circuit units.

With reference to the above description, when the first folding area 211 and the second folding area 212 are expanded with respect to the first folding axis 22, the first display area 2112 and the second display area 2122 are in a state of light emission for display, and the first driving integrated circuit 2116 will output corresponding data signals to the first display area 2112. Furthermore, by synchronously controlling the first synchronization signal, the second driving integrated circuit 2126 will simultaneously output corresponding data signals to the second display area 2122, and at least one of the first driving integrated circuit 2116 or the second driving integrated circuit 2126 simultaneously outputs corresponding scan signals to the display area. In addition, when the first folding area 211 and the second folding area 212 are folded with respect to the first folding axis 22 (that is, in a folded state), one of the first display area 2112 or the second display area 2122 will emit light for display, and the other one will be in a dark-screen state. The following description is an example of which the first display area 2112 emits light for display and the second display area 2122 is in the dark-screen state. The first driving integrated circuit 2116 will output corresponding data signals to the first display area 2112, and by synchronously controlling the first synchronization signal, the second driving integrated circuit 2126 does not need to output corresponding data signals to the second display area 2122 synchronously at the same time. At least one of the first driving integrated circuit 2116 or the second driving integrated circuit 2126 simultaneously outputs corresponding scan signals to the display area. In this example, since the second driving integrated circuit 2126 does not need to output corresponding data signals to the second display area 2122, a power-saving effect is achieved. Further, if the corresponding scan signals are transmitted by the first driving integrated circuit 2116, the second driving integrated circuit 2116 may stop driving, and the second display area 2122 is in a standby state. When the second driving integrated circuit 2126 receives a wake-up signal pulse (for example, when the first folding area 211 and the second folding area 212 are expanded with respect to the first folding axis 22 again), the second display area 2122 will change from the standby state to a normal working mode with light emission for display. It can be understood that situations of which the first display area 2112 is in the dark-screen state and the second display area 2122 emits light for display can be described by using the above description, and will not be repeated here.

In the present embodiment, the first driving integrated circuit 2116 is responsible for transmitting corresponding data signals to the first display area 2112, and the second driving integrated circuit 2126 is responsible for transmitting corresponding data signals to the second display area 2122. It can be seen that the display areas located corresponding to the driving integrated circuits located in different folding areas can be independently controlled and operated one-to-one by the driving integrated circuits. That is, the first driving integrated circuit 2116 located in the first folding area 211 may control the first display area 2112 to emit light for display, and the second driving integrated circuit 2126 located in the second folding area 212 may control the second display area 2122 to emit light for display, so as to achieve an effect of power consumption saving. It can be understood that the corresponding scan signals configured to emit light for display is provided by at least one of the first driving integrated circuit 2116 or the second driving integrated circuit 2126.

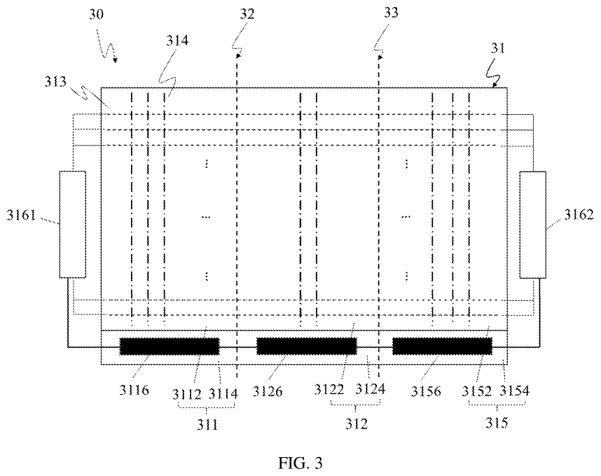

Referring to FIG. 3, which is a schematic diagram showing a foldable display panel 30 according to a second embodiment of the present invention. The present invention may be implemented not only for foldable display panels with two folding areas, but also for foldable display panels with three folding areas. The foldable display panel 30 with three folding areas is showed in the second embodiment of the present invention. Compared with the second embodiment described above, a substrate 31 further includes a third folding area 315. The third folding area 315 is disposed at a side of a second folding area 312 away from a first folding area 311, the third folding area 315 has a third display area 3152 and a third non-display area 3154, and the second folding area 312 and the third folding area 315 are configured to be folded along a second folding axis 33. That is, a third display area 3152 and a second display area 3122 are configured to be folded along the second folding axis 33, and a third non-display area 3154 and a second non-display area 3124 are configured to be folded along the second folding axis 33. Also, the substrate 31 is divided into one side of the second folding area 311 having the second display area 3122 and the second non-display area 3124 and one side of the folding area 315 having the third display area 3152 and the third non-display area 3154 by the second folding axis 33. A third driving integrated circuit 3156 is disposed at the third non-display area 3154 of the substrate 31. That is, a first driving integrated circuit 3116, a second driving integrated circuit 3126, and the third driving integrated circuit 3156 are disposed at different folding areas.

In the present embodiment, a plurality of scan lines 313 and a plurality of data lines 314 are disposed in a display area (that is, the first display area 3112, the second display area 3122, and the third display area 3152), wherein the plurality of scan lines 313 are arranged in a first direction running through the first display area 3112, the second display area 3122, and the third display area 3152. The plurality of data lines 314 are arranged in a second direction intersecting with the first direction, and are arranged as parallel to or as not intersecting with a first folding axis 32. In an embodiment, the first direction and the second direction are perpendicular to each other, for example, the first direction is a row direction, the second direction is a column direction, that is, the plurality of scan lines 313 are arranged in the row direction, the plurality of data lines 314 are arranged in the column direction.

In the present embodiment, the first driving integrated circuit 3116, the second driving integrated circuit 3126, and the third driving integrated circuit 3156 may be located at the non-display areas located at a same end of different folding areas in the column direction, or may be located at different ends of different folding areas in the column direction. As described in the first embodiment of the present invention, it will not be repeated here.

In the present embodiment, the first driving integrated circuit 3116 may be electrically connected to pixel driving circuit units located in the first display area 3112 through corresponding data lines (not marked) located in the first display area 3112 to provide corresponding data signals to the first display area 3112. The second driving integrated circuit 3126 may be electrically connected to the pixel driving circuit units located in the second display area 3122 through corresponding data lines (not marked) located in the second display area 3122 to provide corresponding data signals the second display area 3122. The third driving integrated circuit 3156 may be electrically connected to the pixel driving circuit units located in the third display area 3152 through corresponding data lines (not marked) located in the third display area 3152 to provide corresponding data signals the third display area 3152.

In the present embodiment, the foldable display panel 30 further includes at least one gate-on-array (GOA) drive circuit, which is disposed on the substrate 31 and located at at least one side of the first folding axis 32 or the second folding axis 33. That is, the GOA drive circuit may include one GOA circuit, or may include two GOA circuits. When there is one GOA circuit, it may exemplarily be located at a non-display area located at a left side of the first display area 3112 or located at a non-display area located at a right side of the third display area 3152. When there are two GOA circuits, they may exemplarily be located at the non-display area located at the left side of the first display area 3112 and the non-display area located at the right side of the third display area 3152, respectively, wherein the non-display areas are areas other than the first non-display area 3114, the second non-display area 3124, and the third non-display area 3154. In order to explain the present invention, two GOA circuits are used as a preferred embodiment to illustrate the present invention, and the two GOA circuits are a first GOA circuit 3161 and a second GOA circuit 3162, respectively. The first GOA circuit 3161 is electrically connected to the first driving integrated circuit 3116 disposed at a same side as the first GOA circuit 3161 with respect to the first folding axis 32 (or with respect to the second folding axis 33). The second GOA circuit 3152 is electrically connected to the third driving integrated circuit 3156 disposed at a same side as the second GOA circuit 3152 with respect to the first folding axis 32 (or with respect to the second folding axis 33), as shown in FIG. 3. Furthermore, the first GOA circuit 3161 and the second GOA circuit 3162 are electrically connected to the pixel driving circuit units located in the display area through corresponding scan lines located in the display area, respectively, and the corresponding scan signals required for light emission for display can be provided by at least one of the first driving integrated circuit 3116 or the third driving integrated circuit 3156. That is, when driving capability of the driving integrated circuits are strong enough, only one driving integrated circuit may be used to transmit the corresponding scan signals to the display area. It can be understood that, because the second driving integrated circuit 3126 is not connected to the GOA circuits, corresponding scan signals required for light emission in the second display area 3122 are provided by at least one of the first driving integrated circuit 3116 or the third driving integrated circuits 3156.

In the present embodiment, in order to achieve a higher resolution, the first driving integrated circuit 3116, the second driving integrated circuit 3126, and the third driving integrated circuit 3156 are connected in a manner of a cascade scheme, so that three driving integrated circuits can be used simultaneously to drive the foldable display panel 30. Specifically, the first driving integrated circuit 3116, the second driving integrated circuit 3126, and the third driving integrated circuit 3156 are electrically connected to each other, and a second synchronization signal is transmitted among the first driving integrated circuit 3116, the second driving integrated circuit 3126, and the third driving integrated circuit 3156. The second synchronization signal is configured to control the first driving integrated circuit 3116, the second driving integrated circuit 3126, and the third driving integrated circuit 3156 to synchronously control driving of the plurality of pixel driving circuit units.

With reference to the above description, when the first folding area 311 and the second folding area 312 are expanded with respect to the first folding axis 22, and the second folding area 312 and the third folding area 315 are expanded with respect to the second folding axis 33, the first display area 3112, the second display area 3122, and the third display area 3152 are in a state of light emission for display, and the first driving integrated circuit 3116 will output corresponding data signals to the first display area 3112. Furthermore, by synchronously controlling the second synchronization signal, the second driving integrated circuit 3126 will simultaneously output corresponding data signals to the second display area 3122, the third driving integrated circuit 3156 will simultaneously output corresponding data signals to the third display area 3152, and at least one of the first driving integrated circuit 3116 or the third driving integrated circuit 3156 simultaneously outputs corresponding scan signals to the display area. In addition, when the first folding area 311 and the second folding area 312 are folded with respect to the first folding axis 32 (that is, in a folded state), one of the first display area 3112 or the second display area 3122 will emit light for display, and the other one will be in a dark-screen state. The following description is an example of which the first display area 3112 is in the dark-screen state, as well as the second display area 3122 and the third display area 3152 emit light for display (that is, the second folding area 312 and the third folding area 315 are expanded with respect to the second folding axis 33 at the same time). In the meanwhile, the first driving integrated circuit 3116 will not output corresponding data signals to the first display area 3112, and by synchronously controlling the second synchronization signal, the second driving integrated circuit 3126 and the third driving integrated circuit 3156 will simultaneously output corresponding data signals to the second display area 3122 and the third display area 3152 synchronously, respectively. At least one of the first driving integrated circuit 3116 or the third driving integrated circuit 3156 simultaneously outputs corresponding scan signals to the display area. In this example, since the first driving integrated circuit 3116 does not need to output corresponding data signals to the first display area 3112, an effect of power consumption saving is achieved. Further, if the corresponding scan signals are transmitted by the third driving integrated circuit 3156, the first driving integrated circuit 3116 may stop driving, and the first display area 3122 is in a standby state. When the first driving integrated circuit 3126 receives a wake-up signal pulse (for example, when the first folding area 311 and the second folding area 312 are expanded with respect to the first folding axis 32 again), the first display area 3122 will change from the standby state to a normal working mode with light emission for display. It can be understood that situations of which the first display area 3112 and the second display area 3122 emit light for display, and the third display area 3152 is in the dark-screen state can be described by using the above description, and will not be repeated here. Further, when the first folding area 311, the second folding area 312, and the third folding area 315 are in the folded state, at least one of the first display area 3112, the second display area 3122, or the third display areas 3152 is in the dark-screen state. This situation may also be explained by using the above description, it will not be repeated here. Persons skilled in this art can configure the states of light emission or dark-screen in the folded state according to requirements. For example, when the first folding area 311 and the second folding area 312 are folded with respect to the first folding axis 32, the first folding area 311 emits light for display while it faces upward, and the second folding area 312 is in the dark-screen state while it faces downward.

In the present embodiment, the first driving integrated circuit 3116 is responsible for transmitting corresponding data signals to the first display area 3112, the second driving integrated circuit 3126 is responsible for transmitting corresponding data signals to the second display area 3122, and the third driving integrated circuit 3156 is responsible for transmitting corresponding data signals to the third display area 3152. It can be seen that the display areas located corresponding to the driving integrated circuits located in different folding areas can be independently controlled and operated one-to-one by the driving integrated circuits. That is, the first driving integrated circuit 3116 located in the first folding area 311 may control the first display area 3112 to emit light for display, the second driving integrated circuit 3126 located in the second folding area 312 may control the second display area 3122 to emit light for display, and the third driving integrated circuit 3156 located in the third folding area 315 may control the third display area 3122 to emit light for display, so as to achieve the effect of power consumption saving. It can be understood that the corresponding scan signals for light emission for display is provided by at least one of the first driving integrated circuit 3116 or the third driving integrated circuit 3156. More details of the second embodiment of the present invention may refer to the first embodiment of the present invention, it will not be repeated here.

It should be understood that there are multiple possible folding approaches in the present invention, that is, light emission and the dark-screen state of the display areas are not limited to the above exemplary description, and two folding areas and three folding areas are used to illustrate the present specification, it should not be construed as a limitation to the present invention. The present invention may include at least three folding areas, which falls within a scope of the present invention without departing from a spirit of the present invention.

Based on the above description, according to the present invention, by disposing the driving integrated circuits at different folding areas and electrically connecting the pixel driving circuit units located in corresponding display areas through corresponding data lines to provide corresponding data signals to the display areas, the display area controlled one-to-one for display is realized, and when at least one of the display areas of the foldable display panel is not required to emit light for display, the driving integrated circuit corresponding to the display area may stop driving to reduce power consumption waste. Further, the present invention can be applied to display panels with three or more display areas. It can be seen that the invention is unobvious and has obvious advantages.

Above all, although the present invention has been disclosed above in the preferred embodiments, the above preferred embodiments are not intended to limit the present application. For persons skilled in this art, various modifications and alterations can be made without departing from the spirit and scope of the present application. The protective scope of the present application is subject to the scope as defined in the claims.

1. A foldable display panel, comprising:
a substrate, at least comprising a first folding area and a second folding area, the first folding area comprising a first display area and a first non-display area, the second folding area comprising a second display area and a second non-display area, the first display area and the second display area configured to be folded along a first folding axis, and the first non-display area and the second non-display area configured to be folded along the first folding axis;
a thin film transistor layer, disposed on the substrate and comprising a plurality of pixel driving circuit units;
a first driving integrated circuit, disposed at the first non-display area of the substrate and electrically connected to pixel driving circuit units located in the first display area through corresponding data lines to provide corresponding data signals to the first display area; and
a second driving integrated circuit, disposed at the second non-display area of the substrate and electrically connected to pixel driving circuit units located in the second display area through corresponding data lines to provide corresponding data signals to the second display area.

2. The foldable display panel as claimed in claim 1, further comprising:
at least one gate-on-array (GOA) drive circuit, disposed on the substrate and located at at least one side of the first folding axis, and electrically connected to the plurality of pixel driving circuit units,
wherein the at least one GOA drive circuit is electrically connected to a driving integrated circuit disposed at a same side as the at least one GOA drive circuit with respect to the first folding axis to provide corresponding scan signals.

3. The foldable display panel as claimed in claim 2, wherein the at least one GOA drive circuit is electrically connected to the plurality of pixel driving circuit units through corresponding scan lines, and the corresponding scan lines are arranged in a direction running through the first display area and the second display area.

4. The foldable display panel as claimed in claim 1, wherein the corresponding data lines located in the first display area and the corresponding data lines located in the second display area are arranged so as to not intersect with the first folding axis.

5. The foldable display panel as claimed in claim 1, wherein the first driving integrated circuit and the second driving integrated circuit are located at a same end of the data lines.

6. The foldable display panel as claimed in claim 1, wherein the first driving integrated circuit and the second driving integrated circuit are electrically connected to each other, a first synchronization signal is transmitted between the first driving integrated circuit and the second driving integrated circuit, and the first synchronization signal is configured to control the first driving integrated circuit and the second driving integrated circuit to synchronously control driving of the plurality of pixel driving circuit units.

7. The foldable display panel as claimed in claim 1, wherein when the foldable display panel is in a folded state, one of the first driving integrated circuit or the second driving integrated circuit stops driving, and a display area corresponding to the driving integrated circuit that stops driving is in a standby state.

8. The foldable display panel as claimed in claim 7, wherein when the driving integrated circuit that stops driving receives a wake-up signal pulse, the corresponding display area changes from the standby state to a normal working mode with light emission for display.

9. The foldable display panel as claimed in claim 1, wherein the substrate further comprises a third folding area comprising a third display area and a third non-display area, the third display area and the second display area are configured to be folded along a second folding axis, and the third non-display area and the second non-display area are configured to be folded along the second folding axis, and the foldable display panel further comprises:
a third driving integrated circuit, disposed at the third non-display area of the substrate and electrically connected to pixel driving circuit units located in the third display area through corresponding data lines to provide corresponding data signals to the third display area.

10. The foldable display panel as claimed in claim 9, further comprising:
at least one gate-on-array (GOA) drive circuit, disposed on the substrate and located at at least one side of any one of the first folding axis or the second folding axis, and electrically connected to the plurality of pixel driving circuit units,
wherein the at least one GOA drive circuit is electrically connected to a driving integrated circuit disposed at a same side as the at least one GOA drive circuit with respect to any one of the first folding axis or the second folding axis to provide corresponding scan signals.

11. The foldable display panel as claimed in claim 9, wherein the at least one GOA drive circuit is electrically connected to the plurality of pixel driving circuit units through corresponding scan lines, and the corresponding scan lines are arranged in a direction running through the third display area.

12. The foldable display panel as claimed in claim 9, wherein the corresponding data lines located in the second display area and the corresponding data lines located in the third display area are arranged so as to not intersect with the second folding axis.

13. The foldable display panel as claimed in claim 9, wherein the first driving integrated circuit, the second driving integrated circuit, and the third driving integrated circuit are located at a same end of the data lines.

14. The foldable display panel as claimed in claim 9, wherein the first driving integrated circuit, the second driving integrated circuit, and the third driving integrated circuit are electrically connected to each other, a second synchronization signal is transmitted among the first driving integrated circuit, the second driving integrated circuit, and the third driving integrated circuit, and the second synchronization signal is configured to control the first driving integrated circuit, the second driving integrated circuit, and the third driving integrated circuit to synchronously control driving of the plurality of pixel driving circuit units.

15. The foldable display panel as claimed in claim 9, wherein when the first folding area and the second folding area are in a folded state, one of the first driving integrated circuit or the second driving integrated circuit stops driving, and a display area corresponding to the driving integrated circuit that stops driving is in a standby state.

16. The foldable display panel as claimed in claim 9, wherein when the second folding area and the third folding area are in a folded state, one of the second driving integrated circuit or the third driving integrated circuit stops driving, and a display area corresponding to the driving integrated circuit that stops driving is in a standby state.

17. The foldable display panel as claimed in claim 9, wherein when the first folding area, the second folding area, and the third folding area are all in a folded state, at least one of the first driving integrated circuit, the second driving integrated circuit, or the third driving the integrated circuit stops driving, and a display area corresponding to the at least one driving integrated circuit that stops driving is in a standby state.

18. The foldable display panel as claimed in claim 17, wherein when the at least one driving integrated circuit that stops driving receives a wake-up signal pulse, the corresponding display areas changes from the standby state to a normal working mode with light emission for display.

19. A foldable display device, comprising the foldable display panel as claimed in claim 1.
